(19) United States
(12) Patent Application Publication
(10) Pub. No.: US 2006/0279161 A1
(43) Pub. Date: Dec. 14, 2006

(54) Rotary electric machine equipped with stator core designed to ensure machine performance

(75) Inventors: Toshiki Hitomi, Nisshin-shi (JP); Shigenobu Nakamura, Anjo-shi (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/449,634

(22) Filed: Jun. 9, 2006

(30) Foreign Application Priority Data
Jun. 10, 2005 (JP) 2005-170969

(51) Int. Cl. H02K 1/00; H02K 1/06

(52) U.S. Cl. 310/216; 310/217

(57) ABSTRACT

A rotary electric machine, such as an automotive alternator or an automotive engine starter motor, is provided which includes a rotor and a stator. The stator is equipped with an annular stator core which has a plurality of magnetic pole teeth facing inwardly and a stator winding. The stator winding includes conductive portions disposed inside slots each of which is formed between adjacent two of the magnetic pole teeth and connecting portions which connect the conductive portions and extend from the slots to define coil ends. The stator core is formed by bending a laminate of strips which extends substantially straight into an annular shape and machining an inner circumferential surface of the laminate to have a high circularity, thereby permitting an air gap between the rotor and the stator to be minimized to improve the performance of the rotary electric machine.

### CROSS REFERENCE TO RELATED DOCUMENT

The present application claims the benefit of Japanese Patent Application No. 2005-170969 filed on Jun. 10, 2005, the disclosure of which is incorporated herein by reference.

### BACKGROUND OF THE INVENTION 1. Technical Field of the Invention

The present invention relates generally to a rotary electric machine, such as an automotive alternator or an automotive engine starter motor, equipped with a stator designed to ensure desired performance of the machine. 2. Background Art

In recent years, rotary electric machines, such as alternators for automotive vehicles, driven by power of the engine have been required to be reduced in size and increased in output and efficiency thereof in order to meet requirements to lower idle speeds of the engine, save the weight of the vehicle, or decrease the volume of an engine compartment in favor of increasing the interior space of the vehicle. As one of approaches to meet such requirements, stator winding wires may be disposed in each slot of a stator core at high densities, that is, the space factor may be increased. The increasing of the space factor may be achieved by leading wire through a plurality of slots formed in a rectangular parallelepiped laminated core to make a stator winding and bending the core into an annular shape. For example, Japanese Patent First Publication No. 9-103052discloses such a technique.

Usually, an air gap between the rotor and the stator of the rotary electric machine which is the greatest in magnetic resistance in a magnetic circuit is a greater factor affecting the output performance of the rotary electric machine. It is, thus, advisable that such an air gap be designed to be as small as possible. In case of automotive alternators, the air gap is typically designed to be 0.15 mm to 0.3 mm.

The rotary electric machines mounted in the engine compartment of the vehicle are usually required to withstand exposure to water solution such as car shampoo, salty water, or other foreign objects in order to maintain the performance thereof. Particularly, the air gap between the outer periphery of the rotor and the inner periphery of the stator is usually very narrow, thus causing the water solution to stay therewithin, which leads to the formation of rust. This results in locking of the rotor and a malfunction in entire operation of the rotary electric machine. The resistance to the rust is typically achieved by coating the inner periphery of the stator with an anti-corrosive paint.

The stator core in the structure, as taught in the above publication, is formed by winding wire through a laminate of rectangular parallelepiped steel plates to make a stator winding and bending the laminate into an annular shape, thus being susceptible to a radial shift or misalignment between adjacent two of the steel plates, which leads to irregularities on an inner peripheral surface of the stator core. Eliminating physical interference between the stator and the rotor rotating inside the stator requires selection of the outer diameter of the rotor to form a desired size of air gap between the outer periphery of the rotor and a portion of the inner periphery of the stator having a maximum inner diameter. An average size of the air gap is, therefore, undesirably large, thus resulting in an increase in magnetic resistance of the air gap and a decrease in output below an expected level.

The radial misalignment between the steel plates will cause some of inside edges the steel plates to project inward, thus resulting in poor adhesion of anti-corrosive paint to the edges and nonuniform thickness of a layer of the anti-corrosive paint when the anti-corrosive paint is applied to the inner peripheral surface of the stator core. This will result in an increase in required amount of the anti-corrosive paint.

### SUMMARY OF THE INVENTION

It is therefore a principal object of the invention to avoid the disadvantages of the prior art.

It is another object of the invention to provide an improved structure of a rotary electric machine which permits an air gap between a rotor and a stator to be minimized to improve the performance thereof.

It is a further object of the invention to provide an improved structure of a rotary electric machine which is designed to minimize rust between a rotor and a stator to avoid locking of the rotor.

According to one aspect of the invention, there is provided a rotary electric machine which may be employed in automotive vehicles. The rotary electric machine comprises: (a) a frame; (b) a rotor retained by the frame; and (c) a stator retained by the frame. The stator is equipped with an annular stator core facing the rotor and a stator winding disposed in the stator core. The stator core has a plurality of magnetic pole teeth facing inwardly and a connecting section connecting the magnetic pole teeth. The stator winding includes conductive portions disposed inside slots each of which is formed between adjacent two of the magnetic pole teeth and connecting portions which connect the conductive portions and extend from the slots to define coil ends. The stator core is formed by bending a laminate of strips which extends substantially straight into an annular shape and machining an inner circumferential surface of the laminate of strips to have a high circularity. This permits an air gap between the rotor and the stator to be minimized to improve the performance of the rotary electric machine and also minimizes rust between the rotor and the stator to avoid locking of the rotor.

In the preferred mode of the invention, the inner circumferential surface of the laminate of strips is coated with a preselected material, thereby resulting in the formation of a flat surface of the inner periphery of the stator core. This avoids inward protrusion of edges of the strips and minimizes the amount of the material used.

The coil ends are sealed by resin to avoid the damage of insulating films on the coil ends which results from cutting chips during machining of the stator core.

An inner circumference of each of the coil ends is located coaxially with an inner circumference of the stator core. This minimizes the amount of battery electrolyte, etc., which enters from outside the frame and stays in the air gap between the rotor and the stator, thus avoiding the formation of rust between the rotor and the stator core.

The rotor may include a pole core having claw magnetic poles and a fan installed on an axially oriented end of the pole core. This further minimizes the amount of battery electrolyte, etc.

An inwardly oriented opening of each of the slots is filled with resin. This avoids the intrusion of cutting chips into the slots during machining of the stator core.

According to another aspect of the invention, there is provided a method of producing a stator core of a rotary electric machine equipped with a rotor facing an inner periphery of the stator core, a plurality of magnetic pole teeth which are formed in the stator core and face inwardly, a connecting section connecting the magnetic pole teeth, and a stator winding including conductive portions disposed inside slots each of which is formed between adjacent two of the magnetic pole teeth and connecting portions which connect the conductive portions and extend from the slots to define coil ends. The method comprises: (a) preparing a laminate of strips which extends substantially straight; (b) bending the laminate an annular shape; and (c) machining an inner circumferential surface of the laminate of strips.

In the preferred mode of the invention, the method further comprises coating the inner circumferential surface of the laminate with a preselected material.

The method may also comprise sealing the coil ends with resin.

The method may also comprise fling an inwardly oriented opening of each of the slots with resin.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a partially longitudinal sectional view which shows the structure of an alternator according to the invention;

FIG. 2 is a perspective view which shows a stator core used in the alternator of FIG. 1;

FIG. 3 is a partially perspective view which shows a portion of an original form of a stator core;

FIG. 4 is a partially sectional view which shows a stator core and a coil end; and

FIG. 5 is a partially sectional view which shows an example of a prior art stator core and a coil end.

### DESCRIPTION OF THE PREFERRED EMBODIMENT

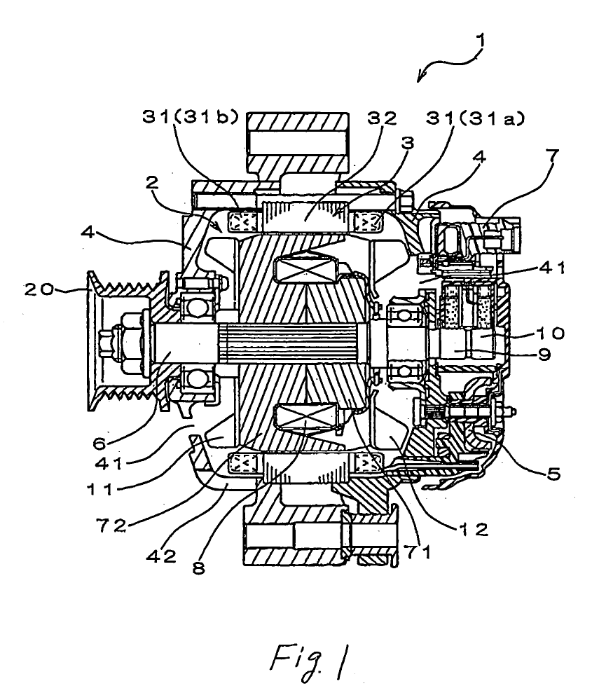

Referring to the drawings, wherein like reference numbers refer to like parts in several views, particularly to FIG. 1, there is shown an AC generator or alternator 1 for automotive vehicles according to the invention.

The alternator 1 consists essentially of a stator 3, a rotor 2, a frame 4, a rectifier device 5, and a regulator 7.

The rotor 2 is equipped with a core assembly made up of a pair of Randel-type pole cores 71 and 72 and a field winding 8. Cooling fans 11 and 12 are secured on front and rear ends of the rotor 2, respectively, to be rotatable following rotation of the rotor 2 to create flows of cooling air. The frame 4 has air inlets 41 formed in front and rear end walls and air outlets 42 formed in a peripheral end wall thereof. The cooling fans 11 and 12 work to suck air into the frame 4 through the air inlets 41 and blow it toward the air outlets 42, thereby cooling a stator winding 31, the rectifier device 5, the regulator 7, etc., installed in the frame 4.

The alternator 1 also includes a shaft 6 to which the rotor 2 is secured. Slip rings 9 and 10 are fitted on the shaft 6. The shaft 6 is retained by the frame to be rotatable. The stator 3 is secured to the frame 4 and faces an outer periphery of the rotor 2.

The shaft 6 is coupled with a pulley 20 driven by output torque of an engine (not shown) mounted in an automotive vehicle. The pulley 20 is joined to the shaft 6 along with the rotor 2. When an existing current is applied to the field winding 8 of the rotor 2 through the slip rings 9 and 10, and the pulley 20 is driven by the engine, it will cause the pole cores 71 and 72 to create N- and S-poles to develop a revolving magnetic field. This induces ac voltage in the stator winding 31 which is, in turn, rectified by the rectifier device 5 to output dc current from output terminals.

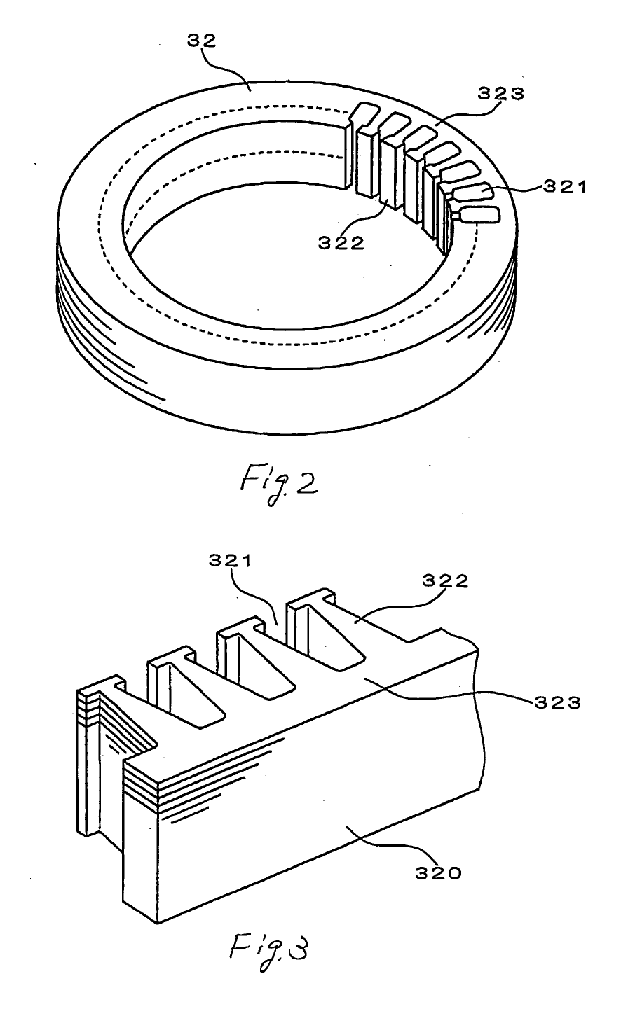

The stator 3 includes the stator core 32 and the stator winding 31. The stator core 32 faces the rotor 2. The stator winding 31 is wound in the stator core 32. FIG. 2 is a perspective view which shows the stator core 32. The stator core 32 is made of a laminate of annular strips (e g., steel plates) and consists of a plurality of pole teeth 322 and a connecting ring 323 connecting the pole teeth 322 together. Adjacent two of the pole teeth 322 define each slot 321. The stator winding 31 is made up of in-slot conductive portions disposed inside the slots 321 and coil ends 31a and 31b which serve as connecting wire and, as illustrated in FIG. 1, protrude from the slots 321 outside ends of the stator core 32 opposed to each other in an axial direction of the stator core 32.

The stator core 32 is not originally formed to be annular, as illustrated in FIG. 2, but to be rectangular parallelepiped. FIG. 3 is a perspective view which shows a portion of an original form of the stator core 32. Specifically, the stator core 32 is originally made of a rectangular parallelepiped member 320 formed by a laminate of plates each having magnetic pole teeth 322 and a connecting straight section 323. The magnetic pole teeth 322 are arrayed in line. The slots 321 are each defined by adjacent two of the magnetic pole teeth 322. The final product of the stator core 32 is formed by passing the stator winding 31 through the slots 321 of the parallelepiped member 320, respectively, bending the parallelepiped member 320 into an annular shape with the tops of the magnetic pole teeth 320 oriented inward, and joining opposed ends of the parallelepiped member 320 into a continuous ring shape. This completes the stator 3. The joining may be achieved by welding or staking. Finally, the inner periphery (i.e., the tops of the magnetic pole teeth 322) of the stator core 32 is machined or turned so as to satisfy a required circularity. This eliminates irregularities on the inner peripheral surface of the stator core 32, thereby enabling relative rotation of the stator 3 to the rotor 2 without any physical interference therebetween. It also becomes possible to minimize the air gap between the rotor 2 and the stator 3, thereby decreasing the magnetic resistance in the air gap to improve the output of the alternator 1.

The cooling fans 11 and 12 are, as described above, secured on the axially-opposed end walls of the pole cores 71 and 72 and work to suck air from outside the frame 4 and discharge it outside the frame 4. This minimizes the amount of battery electrolyte, etc., which enters from outside the frame 4 and stays in the air gap between the rotor 2 and the stator 3, thus avoiding the formation of rust between the rotor 2 and the stator core 32.

While the present invention has been disclosed in terms of the preferred embodiment in order to facilitate better understanding thereof, it should be appreciated that the invention can be embodied in various ways without departing from the principle of the invention.

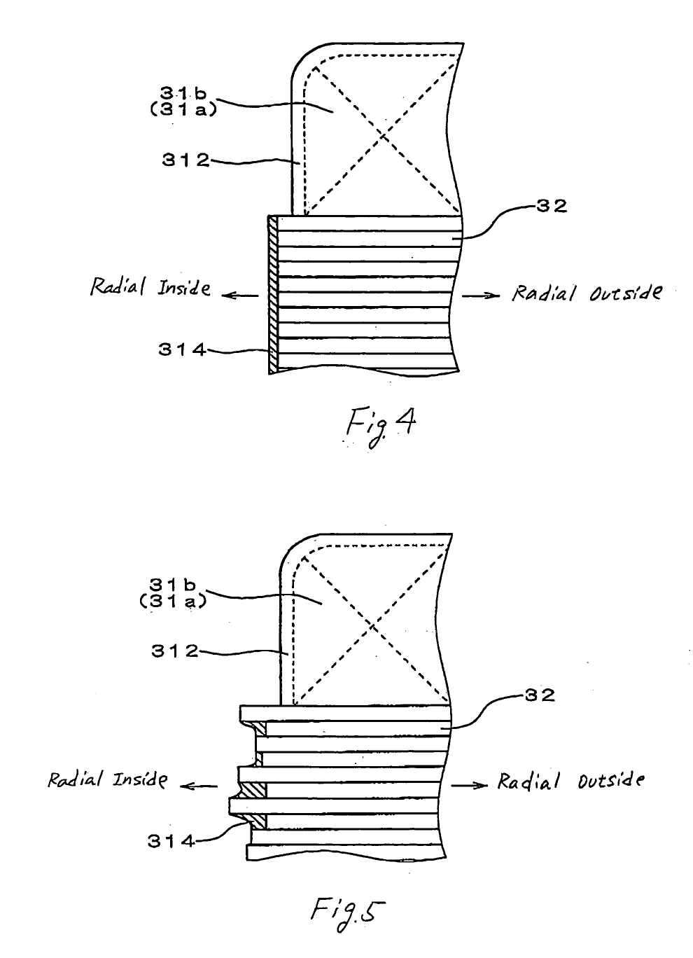

For example, after machined, the inner peripheral wall of the stator core 32 may be preserved or treated with rust inhibitor. FIG. 4 shows a modification of the stator core 32 which has the inner peripheral wall coated with anti-corrosive paint 314. FIG. 5 illustrates the inner peripheral wall of the stator core 32 when coated with the anti-corrosive paint 314 without being machined. In this case, edges of the annular strips of the stator core 32 may project inwardly, thus resulting in lack of adhesion of the anti-corrosive paint 314 to the edges and reduction in effect of the rust prevention. The application of the anti-corrosive paint 314 to the machined inner peripheral wall of the stator core 32, as illustrated in FIG. 4, will avoid the formation of rust between the rotor 2 and the stator core 32 contributing to locking of the stator 2. The edges of the annular strips of the stator core 32 lie flush with each other, thus resulting in uniform thickness of the anti-corrosive paint 314, which minimizes the required amount of the anti-corrosive paint 314.

The coil ends 31a and 31b of the stator windings 31 may be, as illustrated in FIGS. 1 and 4, covered or sealed with resin layers 312 to avoid mechanical damage of an insulating film on the stator winding 31 which results from metal cutting chips during machining of the inner peripheral wall of the stator core 32. This ensures the accuracy of inner diameter of the stator core 32 without sacrificing the environmental resistance of the stator windings 31.

Inner circumferences of the coil ends 31a and 31b (i.e., annular arrays of the resin layers 312 or annular arrays of coil end turns) may be coaxial with the inner circumference of the stator core 32, thereby further decreasing the amount of battery electrolyte, etc., which enters from outside the frame 4 and stays in the air gap between the rotor 2 and the stator 3, thus enhancing the effect of avoiding the formation of rust between the rotor 2 and the stator core 32. The inner circumference of the arrays of the resin layers 312 may be made smooth to minimize the turbulence of cooling air, as produced by the cooling fans 11 and 12 installed on the ends of the stator 2, which will result in a decrease in noise of the cooling air.

An air gap between adjacent two of the magnetic pole teeth 322 along the inner circumference of the stator core 32, that is, inside openings of the slots 321 may be filled with the resin layers 312 or another coil bonding resin material. This avoids the intrusion of metal cutting chips into the slots 321 during machining of the inner peripheral wall of the stator core 32, thus avoiding mechanical damage of the insulating films of the stator winding 31 and facilitating ease of coating the inner peripheral wall of the stator core 32 without sacrificing the environmental resistance of the stator windings 31.

What is claimed is:

1. A rotary electric machine for a vehicle comprising:
a frame;
a rotor retained by said frame; and
a stator retained by said frame, said stator being equipped with an annular stator core facing said rotor and a stator winding disposed in the stator core, the stator core having a plurality of magnetic pole teeth facing inwardly and a connecting section connecting the magnetic pole teeth, the stator winding including conductive portions disposed inside slots each of which is formed between adjacent two of the magnetic pole teeth and connecting portions which connect the conductive portions and extend from the slots to define coil ends, the stator core being formed by bending a laminate of strips which extends substantially straight into an annular shape and machining an inner circumferential surface of the laminate of strips.

2. A rotary electric machine as set forth in claim 1, wherein the inner circumferential surface of the laminate of strips is coated with a preselected material.

3. A rotary electric machine as set forth in claim 1, wherein the coil ends are sealed by resin.

4. A rotary electric machine as set forth in claim 3, wherein an inner circumference of each of the coil ends is located coaxially with an inner circumference of said stator core.

5. A rotary electric machine as set forth in claim 2, wherein said rotor includes a pole core having claw magnetic poles and a fan installed on an axially oriented end of the pole core.

6. A rotary electric machine as set forth in claim 1, wherein an inwardly oriented opening of each of the slots is filled with resin.

7. A method of producing a stator core of a rotary electric machine equipped with a rotor facing an inner periphery of the stator core, a plurality of magnetic pole teeth which are formed in the stator core and face inwardly, a connecting section connecting the magnetic pole teeth, and a stator winding including conductive portions disposed inside slots each of which is formed between adjacent two of the magnetic pole teeth and connecting portions which connect the conductive portions and extend from the slots to define coil ends, the method comprising:
preparing a laminate of strips which extends substantially straight;
bending said laminate an annular shape; and
machining an inner circumferential surface of the laminate of strips.

8. A method as set forth in claim 7, further comprising coating the inner circumferential surface of the laminate with a preselected material.

9. A method as set forth in claim 7, further comprising sealing the coil ends with resin.

10. A method as set forth in claim 7, further comprising filling an inwardly oriented opening of each of the slots with resin.
